(19) United States
(12) Patent Application Publication
(10) Pub. No.: US 2018/0297827 A1
(43) Pub. Date: Oct. 18, 2018

(54) EXTRACTING DEVICES AND RELATED METHODS

(71) Applicant: Lance Eugene Cooper, St. Louis, MO (US)

(72) Inventor: Lance Eugene Cooper, St. Louis, MO (US)

(21) Appl. No.: 15/488,112

(22) Filed: Apr. 14, 2017

(51) Int. Cl. B66F 1/02; G01N 9/00; G01N 23/20

(52) U.S. Cl. CPC B66F 1/02; G01N 9/00; G01N 23/20008; G01N 2223/633; G01N 2223/613; G01N 2223/616; B66F 2700/025

(57) ABSTRACT

Exemplary embodiments are disclosed of extracting devices and related methods. One example device for extracting an object from a material includes a frame attachable to the object to be extracted. An advancer is provided in the frame. An extraction rod is selectively movable through the frame and advancer to position the extraction rod against a surface alongside an exposed portion of the object. A movable handle is pivotally attached to the frame and operable to move the advancer against the extraction rod positioned against the surface, to move the frame along the extraction rod, and the object to which the frame is attached, away from the material.

### FIELD

The present disclosure generally relates to extracting devices and related methods.

### BACKGROUND

This section provides background information related to the present disclosure which is not necessarily prior art.

Soil or other materials on which construction is to take place typically are evaluated for specific density and moisture in order to prevent settlement and failure of structures during and after construction. Materials and/or soils may be placed at a construction site and compacted by heavy equipment and then tested by a nuclear density gauge for density and moisture content. At a surface location where nuclear density testing is to be performed, a drive pin typically is driven into the soil or material surface and then is extracted to provide a hole. A nuclear density gauge then is used to lower a rod containing a radioactive isotope into the hole to emit radiation. Radiation that is emitted and reflected back to the nuclear density gauge by the material and the moisture within the material may be used to calculate the density and moisture content of the material.

### DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1A is a side view of an example extracting device in accordance with example embodiments of the disclosure;

FIG. 1B is a perspective view of a movable handle of an example extracting device in accordance with example embodiments of the disclosure;

FIG. 1C is a top view of a movable handle of an example extracting device in accordance with example embodiments of the disclosure;

FIG. 1D is a rear view of a rod release of an example extracting device in accordance with example embodiments of the disclosure;

FIG. 1E is a rear view of a rod release of an example extracting device in accordance with example embodiments of the disclosure, the rod release being shown as connected with components of a frame of the extracting device;

FIG. 2 is a side view of an example extracting device configured to extract an object from a material in accordance with example embodiments of the disclosure;

FIG. 3 is a perspective view of an example advancer in accordance with example embodiments of the disclosure;

FIG. 4 is a top view of an example wrench-type object attachment in accordance with example embodiments of the disclosure;

FIG. 5 is a top view of an example clevis-type object attachment in accordance with example embodiments of the disclosure;

FIG. 6A is a side view of an object attachment connector in accordance with example embodiments of the disclosure;

FIG. 6B is a top view of an object attachment connector in accordance with example embodiments of the disclosure; and

FIG. 6C is a side view of an example object attachment connector and object attachment, shown below an extracting device frame in accordance with example embodiments of the disclosure.

### DETAILED DESCRIPTION

Example embodiments will now be described more fully with reference to the accompanying drawings.

The inventor hereof has recognized that when, e.g., nuclear density testing is performed, traditional methods for extracting drive pins from soil or other material typically require the use of back muscles by the person extracting a pin. The person pulling the pin often has to assume an awkward body position, often while working on uneven terrain, in order to pull a pin. Back strains and injuries are common and typically a risk factor in pulling pins.

Accordingly, the inventor has developed and discloses herein exemplary embodiments of extracting devices and related methods. In one example embodiment, an extracting device is provided for extracting an object from a material. The example extracting device includes a frame that is connectable to the object to be extracted. An extraction rod is configured to be positioned on a surface alongside an exposed portion of the object. The extraction rod is selectively movable through the frame and through an advancer provided in the frame. A movable handle is pivotally attached to the frame and operable to move the advancer toward and against the extraction rod, to move the frame along the extraction rod, and to move the object to which the frame is connected, away from the material.

Although embodiments are described herein with reference to extracting drive pins from soil and with reference to nuclear density testing applications, the disclosure is not so limited. Various embodiments may be used for pulling and/or extracting various types of objects from various types of materials, including but not limited to compacted materials. Such objects include (without limitation) rods, dowels, stakes, other mechanically or manually driven objects, etc.

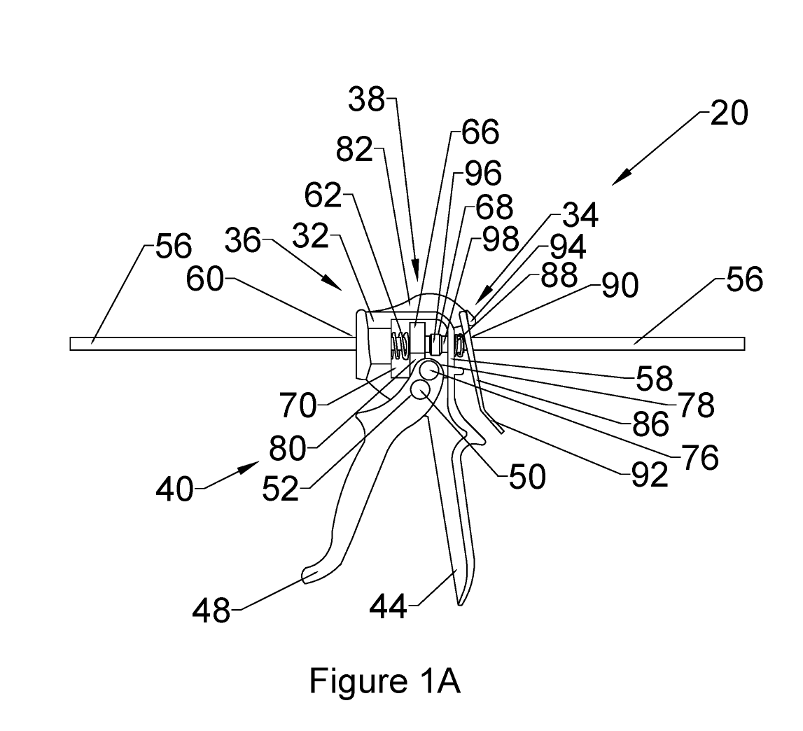

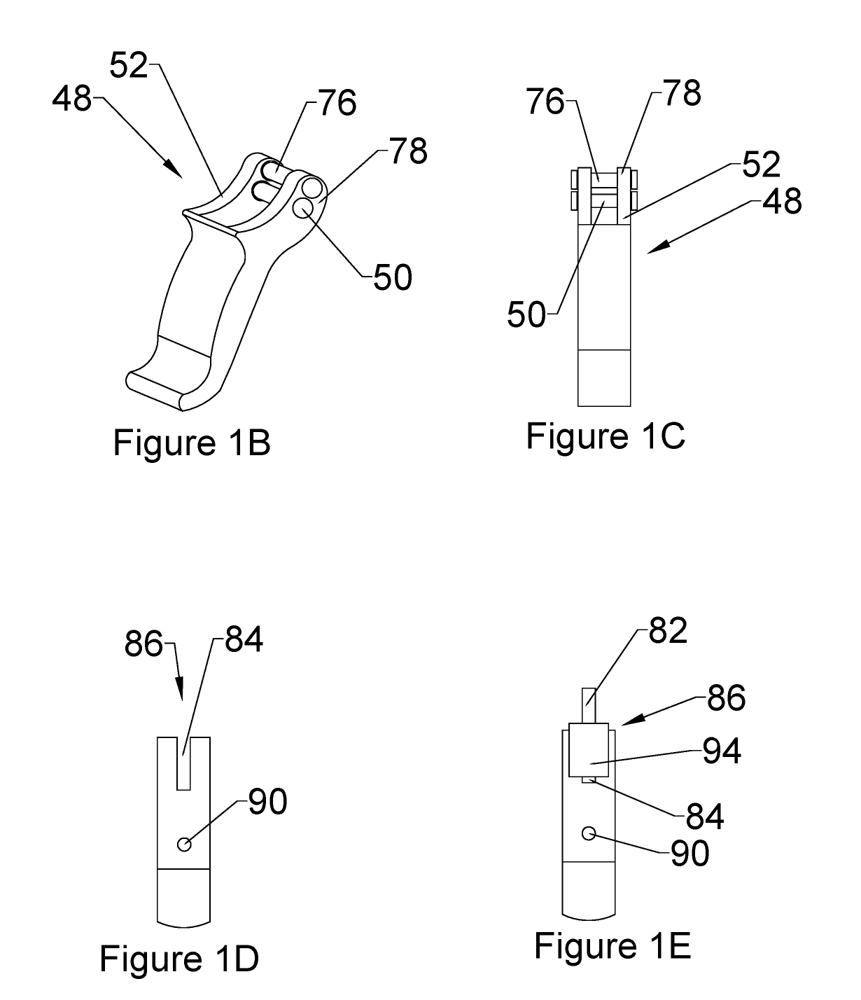

Referring now to the figures, FIGS. 1A-1E and 2 illustrate an example extracting device 20 provided for extracting a pin 24 or other object from soil or other material through a surface 28. In the present example embodiment, the pin 24 is used to create a hole for nuclear density testing. The extracting device 20 includes a frame 32 having a proximal portion 34, a distal portion 36, an upper portion 38, and a lower portion 40. A fixed handle 44 extends from the lower portion 40. A movable handle 48 is pivotally attached to the frame lower portion 40 by a pivot pin 50 extending transversely through the lower frame portion 40 and through two arms 52 of the movable handle 48 between which the frame 32 is positioned. An extraction rod 56 extends through the frame 32, e.g., through a proximal bore 58 and a distal bore 60. In various embodiments, the extraction rod 56 is longer than the object to be extracted and may be removed from the frame 32, e.g., for replacement by another extraction rod.

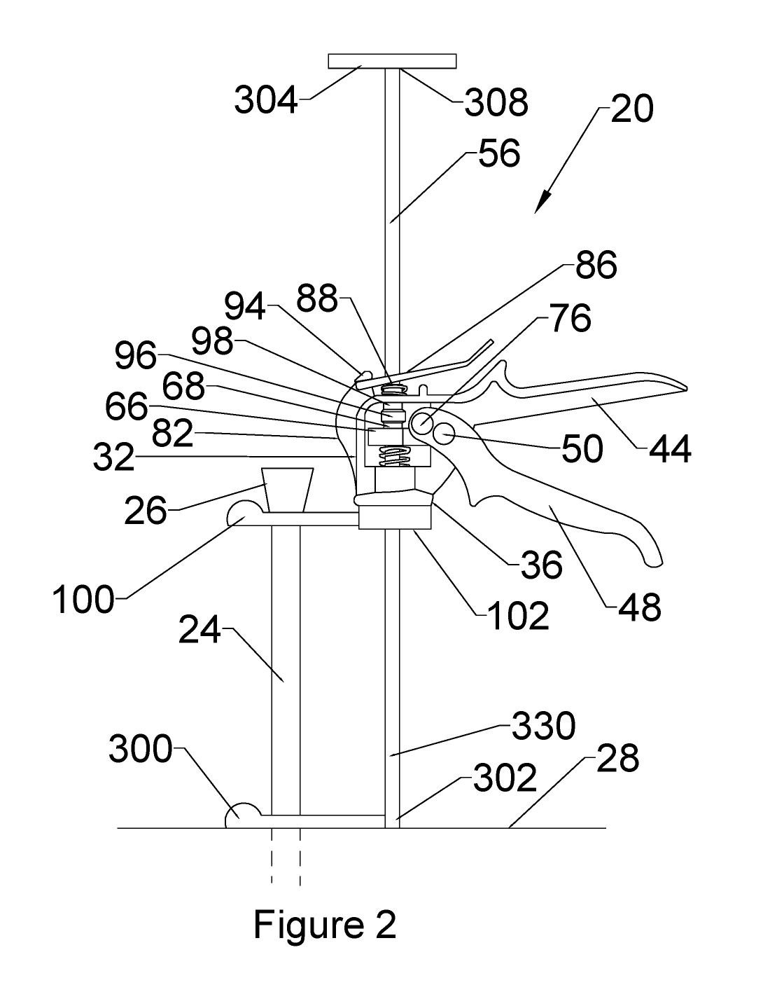

The frame 32 houses an interior compression spring 62 and an advancer 66 in an opening 70 of the frame 32. A spacer sleeve 68 also is provided in the opening 70. The spacer sleeve 68 includes a central stop portion 96. A proximal portion 98 of the spacer sleeve 68 extends through the frame proximal bore 58 and into an exterior compression spring 88. The advancer 66 is shown in greater detail in FIG. 3. The extraction rod 56 extends through the interior spring 62, through a bore 72 of the advancer 66, and through the spacer sleeve 68. As shown in FIG. 3, the bore 72 of the advancer 66 defines an inner surface 74 of the advancer 66 and is sized to provide a close fit for the extraction rod 56 through the advancer 66.

The movable handle 48 is shown in greater detail in FIGS. 1B-1C. The movable handle 48 includes a pusher 76, e.g., a pin extending transversely through the frame opening 70 and upper ends 78 of the movable handle arms 52. The movable handle 48 is operable to move the pusher 76 against a tip 80 of the advancer 66, thereby pushing the advancer 66 distally against the interior spring 62 and obliquely against the extraction rod 56. A crest 82 of the frame 32 extends proximally from the frame upper portion 38 and is positioned in a slot 84 of the rod release 86. The rod release 86 is spaced apart from the frame 32 by the exterior compression spring 88, which, together with a crest protrusion 94, locks the extraction rod 56 at the rod release 86. The crest protrusion 94 retains the crest 82 in the slot 84 to keep the rod release 86 in tension against the extraction rod 56 until a user presses a lower portion 92 of the rod release 86 toward the fixed handle 44 to release the extraction rod 56. The extraction rod 56 extends through the exterior spring 88 and through a bore 90 of the rod release 86. The rod release 86 is shown in greater detail in FIGS. 1D-1E. The bore 90 is sized to provide a close fit for the extraction rod 56 through the rod release 86. The interior and exterior springs 62 and 88, and also the spacer sleeve 68, have interior diameters sized to provide a close fit for the extraction rod 56 through the springs (62, 88) and through the spacer sleeve 68.

When a user of the extracting device 20 has pressed the lower portion 92 of the rod release 86 distally toward the fixed handle 44, the extraction rod 56 is selectively movable proximally and/or distally through the frame 32, interior spring 62, advancer 66, spacer sleeve 68, exterior spring 88, and rod release 86. In various embodiments, releasing the extraction rod 56 allows a user to adjust the position of the frame 32 on the extraction rod 56 appropriately relative to a length of a pin to be extracted.

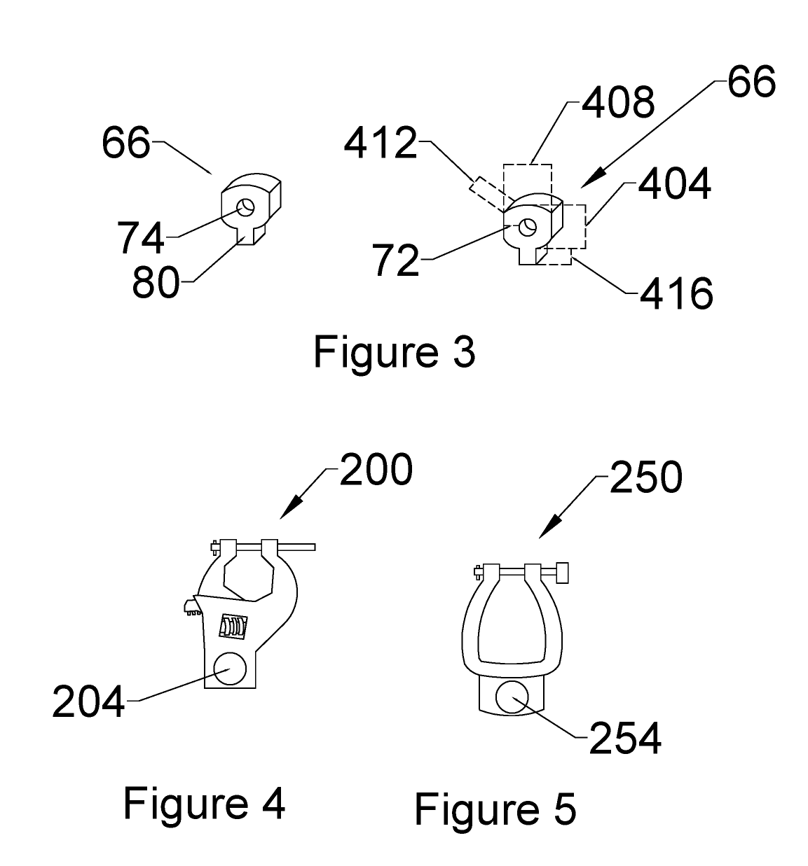

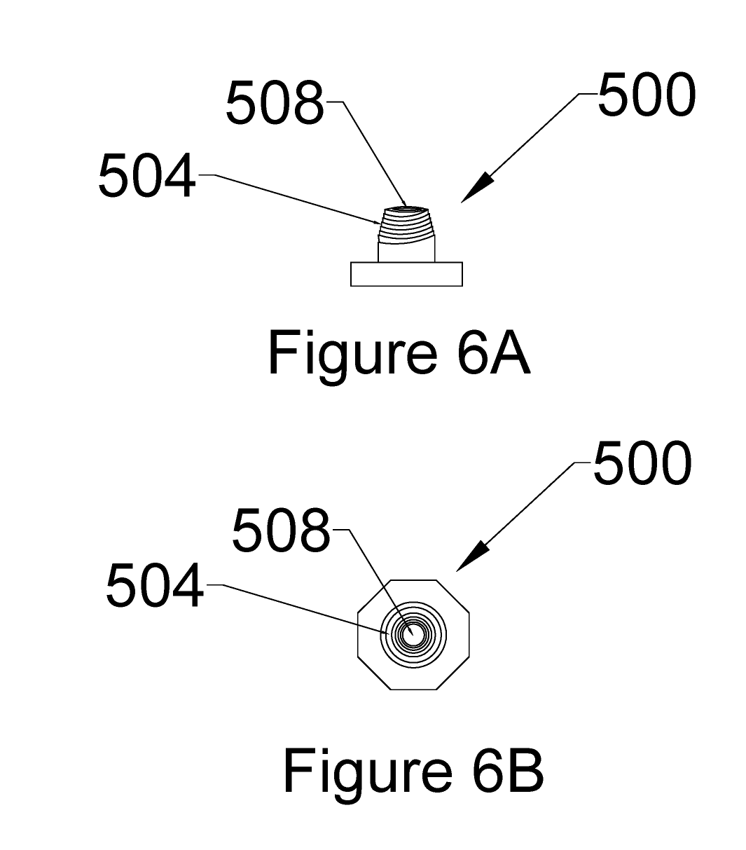

As shown in FIG. 2, an object attachment 100 is affixed, e.g., via a connector 102, to the distal portion 36 of the frame 32 and extends outwardly from the distal portion 36. The object attachment 100 is for fixedly connecting to the frame 32 a portion of the pin 24 extending from the surface 28. Various types and sizes of object attachments may be used, dependent, e.g., on the type of object to be extracted. For example, in an embodiment shown in FIG. 4, an object attachment 200 is adjustable and is similar to a wrench. The wrench-type object attachment 200 includes a bore 204 configured to align with the distal bore 60 of the frame 32, to allow insertion of the extraction rod 56 through the frame 32 and object attachment 200. As further described below, the bore 204 may also be sized so as to allow a connector to be inserted through the bore 204 for connecting the object attachment 200 to the frame 32. The wrench-type object attachment 200 may be attached onto a pin or other object and may be adjusted to securely hold the pin or other object during extraction. In an embodiment shown in FIG. 5, an example clevis-type object attachment 250 is configured for attachment to the frame 32. A bore 254 is provided for insertion of the extraction rod 56, and, in various embodiments, insertion of a connector as further described below, through the clevis-type object attachment 250.

In various embodiments, various types of object attachments and/or connectors could be used in relation to an extracting device frame. In some embodiments, an object attachment and a connector could be provided as a single unit attachable to an extracting device frame. For example, as shown in FIG. 2, the object attachment 100 is welded together with the connector 102, and the connector 102 is affixed to the frame 32, e.g., by threading, sleeve, and/or other connection technique(s).

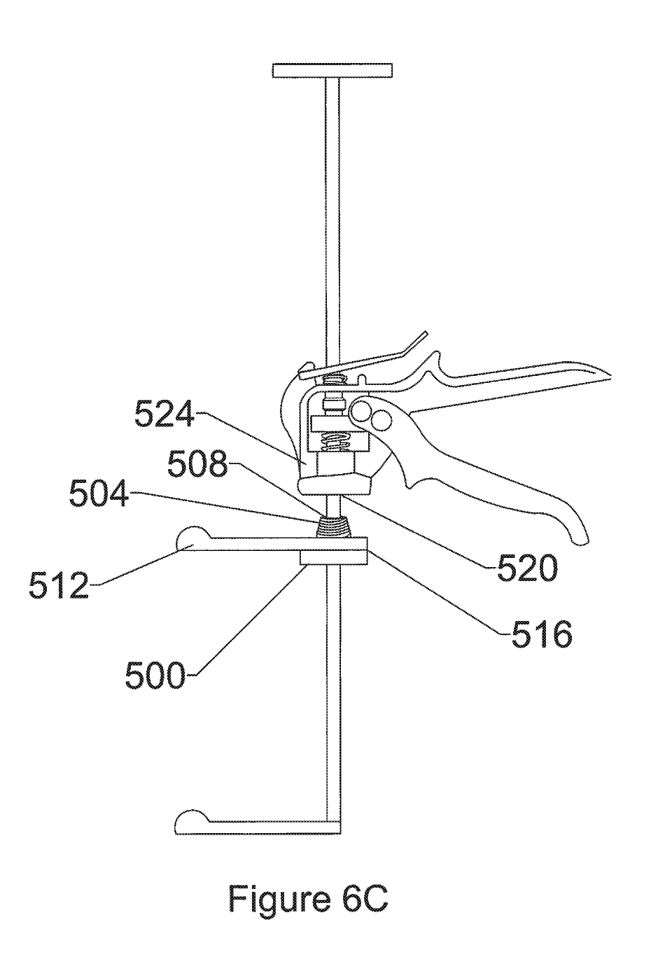

As shown in FIGS. 6A through 6C, an example connector 500 has a threaded stem 504 through which a bore 508 is provided. In the example embodiment of FIG. 6C, a bore (not shown) of an object attachment 512 may be placed over the threaded stem 504 and the object attachment 512 may be sleeve-connected and/or welded onto the connector 500 to form a connection 516. Thereafter the threaded stem 504 of the connector 500 may be threaded into a corresponding threaded channel 520 of an extracting device frame 524, thereby securing the object attachment 512 to the frame 524.

Referring again to FIG. 2, a base attachment 300 is affixed, e.g., by a welded connection, to a distal end 302 of the extraction rod 56. Other types of connection between an extraction rod and a base attachment are possible in various embodiments, including but not limited to connections that are sleeved, threaded, etc. The base attachment 300 may be of the same type as, or similar to, the object attachment 100. The size, shape and/or type of a base attachment can depend, e.g., on the type of surface (which may be a plate positioned on soil or other material) against which the base attachment is to be positioned, the type of pin or other object to be extracted, etc. For safety, an optional rod cover 304 may be attached, e.g., by a threaded connection, to a proximal end 308 of the extraction rod 56.

The extracting device 20 may be used, e.g., in the following example manner. While the user presses the rod release 86 so that the extraction rod 56 is selectively movable relative to the frame 32, the user pushes and/or pulls the extraction rod 56 relative to the frame 32 to provide a distal length 330 of the extraction rod 56 appropriate for seating the object attachment 100 securely onto an exposed portion of the pin 24 and for positioning the base attachment 300 over the exposed pin portion and onto the surface 28 near the exposed pin portion. The extraction rod 56 is thereby positioned, e.g., so as to be parallel with the pin 24 to be extracted. The movable handle 48 may be squeezed together with the fixed handle 44 to move the frame 32 away from the surface 28, to thereby snugly secure the object attachment 100 against the pin 24 and to snugly secure the base attachment 300 against the surface 28. In the present example embodiment, the pin 24 has a head 26 against which the object attachment 100 is pulled by the movement of the frame 32 away from the surface 28. Other or additional object attachment types are contemplated for extracting various types of objects. For example, in order to extract an object that has a bore or channel, an object attachment could be used that has an appropriately shaped protrusion that may be inserted through the bore or channel.

When the object attachment 100 has been secured to the pin 24 and the base attachment 300 has been secured against the surface 28, the user can extract the pin 24, e.g., by repeatedly grasping and squeezing the fixed handle 44 and movable handle 48 together, and/or by repeatedly pulling the movable handle 48 independently upward. In one example embodiment, when the user rotates the movable handle 48 toward the fixed handle 44, the movable handle 48 moves the pusher 76 against the advancer tip 80 distally and obliquely toward the extraction rod 56. The advancer 66 thus is pushed against the interior spring 62 while the inner surface 74 of the advancer 66 grips the extraction rod 56 to drive the extraction rod 56 distally. Since the distal end 302 of the extraction rod 56 is kept stationary on the surface 28, the driving force of the advancer 66 causes the frame 32 and object attachment 100 to be moved proximally along the extraction rod 56. The attached pin 24 also is moved proximally and in parallel with the extraction rod 56.

As the advancer 66 is moved distally and its inner surface 74 is pushed obliquely against the extraction rod 56 to drive the extraction rod 56, the frame crest 82 tends to be pushed downwardly against the rod release 86. The rod release 86 remains locked in place by the exterior spring 88, which keeps the extracting device 20 in tension as the frame 32 and pin 24 are moved together proximally. After advancing the frame 32 and pin 24, the user releases the movable handle 48, and the interior spring 62 decompresses and returns the advancer 66 to its original position adjacent the spacer sleeve 68. The stop 96 of the spacer sleeve 68 causes the advancer 66 to be returned to a position that allows the released movable handle 48 to stop moving when it has reached a desirable position (e.g., a position comfortable and/or convenient for subsequent user operation) relative to the fixed handle 44. The user may repeat the above sequence until the pin 24 (or a desired portion of the pin) is extracted from the material.

In various implementations the user performs hand flexing, grasping and/or pulling of the movable handle 48 in an upward motion parallel with the extraction rod 56 and pin 24. In one example implementation, if the extraction rod 56 and pin 24 become, e.g., more than ten (10) degrees out of parallel with each other, the user may push the rod release 86 to release the extraction rod 56. The user may then reset the extracting device 20 so that the extraction rod 56 is parallel with the pin 24. In various embodiments, the extracting device may be configured to extract a pin or other object that is not perpendicular to the ground. For example, in some implementations a non-level base attachment may be placed on the soil surface so as to compensate for a non-perpendicular object.

It should be noted that an advancer may be provided in various forms and configurations. As shown in FIG. 3, the example advancer 66 is a T-grommet having a roughly “T”-shaped outer profile 400. In some other example embodiments, an advancer may have an oval outer profile, a rectangular outer profile, etc. Additionally or alternatively, although the interior spring 62, advancer 66, and spacer sleeve 68 are provided in the frame opening 70, various embodiments are contemplated in which the frame 32 at least partially covers the opening 70. In the present example embodiment, the interior spring 62 extends past the opening 70 into the distal portion 36 of the frame 32, thereby allowing a single hand flex to pull a longer portion of the rod 56 through the extracting device 20 than would be the case in an embodiment in which the spring 62 is retained in the opening 70. In some embodiments, a stop may be provided in a form other than a sleeve. Such alternative forms may include advancer protrusion(s), frame protrusion(s), etc.

One example embodiment may be configured as follows. The movable handle 48 may be 6 inches or more in length. The fixed handle 44 may be 8 inches or more in length and 0.75 inch or more in thickness. A span of three inches may be provided between the fixed and movable handles. The pivot pin 50 and pusher 76 may each have a thickness of one-fourth of the diameter of the extraction rod 56. Referring to FIG. 3, the advancer 66 may have a height 404 and width 408 of 1.5 times the diameter of the extraction rod 56, and a thickness 412 of up to the diameter of the extraction rod 56. The advancer tip 80 may have a height 416 of up to the diameter of the extraction rod 56. The rod release 86 may have a length of 3.5 inches or more, dependent, e.g., on the size of the extracting device 20. The spacer sleeve 68 may have a length twice the diameter of the extraction rod 56. The foregoing dimensions are examples only, however, and may vary in accordance with, e.g., overall size of the extracting device and/or in accordance with strength needed to extract a given object. Embodiments also are possible, for example, in which one or more dimensions are smaller and/or larger than as described above. In various embodiments, most if not all extracting device components are made of steel alloy(s). Other or additional materials could be used in some embodiments, dependent on such factors as size, particular use, etc.

In various embodiments, the frame 32 and extraction rod 56 are configured to make it possible to adapt the extracting device 20 for use in relation to different sizes of objects to be extracted. In various embodiments the extraction rod 56 has a diameter in accordance with strength needed to extract a given object. Similarly, the interior and exterior springs 62 and 88 have outside diameters in accordance with strength needed to extract the given object. In various embodiments, an extraction rod 56 could be easily interchanged on a given frame 32 to obtain an appropriate rod length for a given extraction task. Additionally or alternatively, embodiments are contemplated in which an interior spring 62, advancer 66, spacer sleeve 68, exterior spring 88, and/or rod release 86 may be provided as separate components that can be easily assembled onto a given extraction rod 56 by a user.

Embodiments of the foregoing devices and methods make it possible to remove a pin with minimal disturbance to materials around the hole formed during the removal. In order to obtain accurate results from nuclear density testing, materials around a pin are not be disturbed during the extraction of the pin. Embodiments of the foregoing devices and methods have been observed to minimally disturb the sidewalls and cavities of holes and voids remaining after extraction of pins. Thus, more consistent sampling for nuclear density testing can be provided as compared to traditional methods.

The foregoing embodiments also provide advantages relating to safety and injury prevention. Extracting a pin or other object might require from 25 to 300 or more pounds of force, which may vary substantially from one object to another. An operator or engineering technician thus may have no way to determine what force he or she will need to exert to pull a given pin from the ground. Pulling with more force than needed on an object could result in injury, just as not exerting enough force to extract an object could result in injury. In contrast to traditional lifting and leverage methods for removing objects from soil or other material, embodiments of the foregoing devices and methods can be used to extract objects by upward mechanical force without undue use of common muscle groups including back, leg, shoulder, and upper arm. Traditional methods include lifting, leverage, the use of lower and upper back muscles, squatting, shoulder and upper arm pulling, and leverage by tools. In contrast, embodiments of the foregoing devices and methods utilize hand and arm muscle groups and a trigger grip squeeze method to remove objects from soil or other material.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Or, for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A device for extracting an object from a material, the device comprising:
a frame connectable to the object to be extracted;
an advancer provided in the frame;
an extraction rod selectively movable through the frame and advancer to position the extraction rod against a surface alongside an exposed portion of the object; and
a movable handle pivotally attached to the frame and operable to move the advancer against the extraction rod positioned against the surface, to move the frame along the extraction rod, and the object to which the frame is connected, away from the material.

2. The device of claim 1, further comprising:
an interior compression spring provided in the frame distal to the advancer and through which the extraction rod is selectively movable; and
a pusher operable by the movable handle to push the advancer against the interior compression spring and extraction rod to drive the frame proximally along the extraction rod.

3. The device of claim 1, further comprising a rod release through which the extraction rod is selectively movable, the rod release selectively operable to hold the extraction rod in tension relative to the frame or to release the extraction rod from tension to allow adjustment of the extraction rod.

4. The device of claim 3, further comprising an exterior compression spring through which the extraction rod is selectively movable;
the exterior compression spring provided between the frame and the rod release.

5. The device of claim 3, the frame further comprising a proximally extending crest movably retained in a slot of the rod release.

6. The device of claim 1, further comprising an object attachment connectable to the frame and configured for attachment to the object to be extracted.

7. The device of claim 6, further comprising a base attachment connectable to the distal end of the extraction rod.

8. A method of extracting an object from and/or through a material, the method comprising the steps of:
connecting an exposed portion of the object to a frame of an extracting device;
positioning, against a surface alongside an exposed portion of the object to be extracted, the distal end of an extraction rod extending through the frame, the positioning performed to place the extraction rod in parallel with the exposed portion of the object; and
operating a movable handle pivotally attached to the frame to push an advancer distally in the frame and against the positioned extraction rod, to move the frame and object proximally relative to the extraction rod.

9. The method of claim 8, wherein the connecting is performed using an object attachment connected to the frame and configured for connection with the object.

10. The method of claim 8, wherein operating the movable handle comprises:
moving the movable handle toward a fixed handle extending from the frame, to push the advancer against the extraction rod and to push an interior compression spring distally against the frame; and
releasing the movable handle to release the interior compression spring, whereby the advancer is moved proximally in the frame.

11. The method of claim 8, wherein the positioning is performed using a base attachment at the distal end of the extraction rod.

12. The method of claim 8, further comprising:
pressing, toward the frame, a rod release through which the rod extends, to adjustably position the extraction rod relative to the frame and object; and
releasing the rod release to press the extraction rod against the frame.

13. The method of claim 8, wherein the operating is repeated until the object is extracted partially or completely from the material.

14. The method of claim 8, performed to extract a drive pin from soil.

15. A device for extracting an object from a material, the device comprising:
a frame configured for connection to a portion of the object extending from the material;
an extraction rod selectively movable through the frame;
an advancer configured to be positioned in the frame and through which the extraction rod is selectively movable; and
a movable handle pivotally attached to the frame and operable, when a distal end of the extension rod is extended through the frame and advancer and supported by a surface near the object, to push the advancer against the extraction rod to move the frame along the extraction rod and the object away from the material.

16. The device of claim 15, wherein the movable handle comprises a pusher extending transversely through the frame and configured to push the advancer obliquely against the extraction rod.

17. The device of claim 16, wherein the advancer comprises an asymmetric shape configured to provide a portion against which the pusher is configured to push.

18. The device of claim 15, further comprising an interior compression spring distally positionable in the frame and over the extraction rod, the interior compression spring configured to return the advancer proximally against a stop in the frame when the movable handle is released.

19. The device of claim 15, further comprising a rod release through which the extraction rod is movable, the rod release having a slot for receiving a proximally extending crest of the frame.

20. The device of claim 15, further comprising:
an object attachment connectable to the frame and configured for attachment to the object to be extracted; and
a base attachment connectable to the distal end of the extraction rod.
